(19) United States
(12) Patent Application Publication
(10) Pub. No.: US 2015/0032664 A1
(43) Pub. Date: Jan. 29, 2015

(54) ANALYSIS PROCESS

(71) Applicant: Aaron Brask Capital LLC, Jupiter, FL (US)

(72) Inventor: AARON BRASK, Jupiter, FL (US)

(21) Appl. No.: 14/297,066

(22) Filed: Jun. 5, 2014

Related U.S. Application Data
(60) Provisional application No. 61/832,324, filed on Jun. 7, 2013.

(51) Int. Cl. G06Q 40/06

(52) U.S. Cl. CPC G06Q 40/06
USPC 705/36 R

(57) ABSTRACT

A method, computer program product, and computing system for determining a first dividend paid during the defined period of time for the one or more shares of the first security. A first Δ net asset value during the defined period of time is calculated for the one or more shares of the first security. A first Δ ownership during the defined period of time is calculated for the one or more shares of the first security. A first performance indicator for the defined period of time is calculated for the one or more shares of the first security based, at least in part, upon the first dividend, the first Δ net asset value, and the first Δ ownership.

### RELATED APPLICATION

This application claims the benefit of U.S. Provisional Patent Application No. 61/832,324, filed on 7 Jun. 2013, and entitled “Fundamental Reporting System and Method”, the entire disclosure of which is incorporated herein by reference.

### TECHNICAL FIELD

This disclosure relates to performance analysis and, more particularly, to performance analysis concerning securities.

### BACKGROUND

When a company issues a security (e.g., a share of stock), that share of stock represents a partial ownership of the company. For example, if a company issues 1,000 shares of stock, each share of stock represents ownership of 0.10% of the company. During the course of any given time period, these securities may be traded at their current market value, wherein this current market value may fluctuate depending upon the perceived value of that share of the company.

Unfortunately, while traditional brokers/advisors usually report the market value of a security (i.e., what the current market prices are for the security), this reporting may be short sighted and may not provide the full picture to the reader of the report.

### SUMMARY OF DISCLOSURE

In one implementation, a computer-implemented method for analyzing one or more shares of a first security during a period of time period includes determining a first dividend paid during the defined period of time for the one or more shares of the first security. A first Δ net asset value during the defined period of time is calculated for the one or more shares of the first security. A first Δ ownership during the defined period of time is calculated for the one or more shares of the first security. A first performance indicator for the defined period of time is calculated for the one or more shares of the first security based, at least in part, upon the first dividend, the first Δ net asset value, and the first Δ ownership.

One or more of the following features may be included. Public financial filings data may be obtained for the first security. The first dividend, the first Δ net asset value, and the first Δ ownership may be based, at least in part, upon the public financial filings data for the first security. The one or more shares of the first security may be included within a group of securities. The group of securities may further include one or more shares of a second security. The group of securities may be included within a stock portfolio. The group of securities may be included within a mutual fund.

A second dividend paid during the defined period of time may be determined for the one or more shares of the second security. A second Δ net asset value during the defined period of time may be calculated for the one or more shares of the second security. A second Δ ownership during the defined period of time may be calculated for the one or more shares of the second security. A second performance indicator for the defined period of time may be calculated for the one or more shares of the second security based, at least in part, upon the second dividend, the second Δ net asset value, and the second Δ ownership. A group performance indicator may be calculated for the group of securities based, at least in part, upon the first performance indicator and the second performance indicator.

In another implementation, a computer program product resides on a computer readable medium and has a plurality of instructions stored on it. When executed by a processor, the instructions cause the processor to perform operations including determining a first dividend paid during the defined period of time for the one or more shares of the first security. A first Δ net asset value during the defined period of time is calculated for the one or more shares of the first security. A first Δ ownership during the defined period of time is calculated for the one or more shares of the first security. A first performance indicator for the defined period of time is calculated for the one or more shares of the first security based, at least in part, upon the first dividend, the first Δ net asset value, and the first Δ ownership.

One or more of the following features may be included. Public financial filings data may be obtained for the first security. The first dividend, the first Δ net asset value, and the first Δ ownership may be based, at least in part, upon the public financial filings data for the first security. The one or more shares of the first security may be included within a group of securities. The group of securities may further include one or more shares of a second security. The group of securities may be included within a stock portfolio. The group of securities may be included within a mutual fund.

A second dividend paid during the defined period of time may be determined for the one or more shares of the second security. A second Δ net asset value during the defined period of time may be calculated for the one or more shares of the second security. A second Δ ownership during the defined period of time may be calculated for the one or more shares of the second security. A second performance indicator for the defined period of time may be calculated for the one or more shares of the second security based, at least in part, upon the second dividend, the second Δ net asset value, and the second Δ ownership. A group performance indicator may be calculated for the group of securities based, at least in part, upon the first performance indicator and the second performance indicator.

In another implementation, a computing system including a processor and memory is configured to perform operations including determining a first dividend paid during the defined period of time for the one or more shares of the first security. A first Δ net asset value during the defined period of time is calculated for the one or more shares of the first security. A first Δ ownership during the defined period of time is calculated for the one or more shares of the first security. A first performance indicator for the defined period of time is calculated for the one or more shares of the first security based, at least in part, upon the first dividend, the first Δ net asset value, and the first Δ ownership.

One or more of the following features may be included. Public financial filings data may be obtained for the first security. The first dividend, the first Δ net asset value, and the first Δ ownership may be based, at least in part, upon the public financial filings data for the first security. The one or more shares of the first security may be included within a group of securities. The group of securities may further include one or more shares of a second security. The group of securities may be included within a stock portfolio. The group of securities may be included within a mutual fund.

A second dividend paid during the defined period of time may be determined for the one or more shares of the second security. A second Δ net asset value during the defined period of time may be calculated for the one or more shares of the second security. A second Δ ownership during the defined period of time may be calculated for the one or more shares of the second security. A second performance indicator for the defined period of time may be calculated for the one or more shares of the second security based, at least in part, upon the second dividend, the second Δ net asset value, and the second Δ ownership. A group performance indicator may be calculated for the group of securities based, at least in part, upon the first performance indicator and the second performance indicator

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an analysis process according to an implementation of the present disclosure;

FIG. 2 is a flowchart of the analysis process of FIG. 1 according to an implementation of the present disclosure; and

FIG. 3 is a diagram showing a graphical representation of data spanning multiple quarters.

Like reference symbols in the various drawings indicate like elements.

### DETAILED DESCRIPTION OF THE PREFERRED EMBODIMENTS

### System Overview:

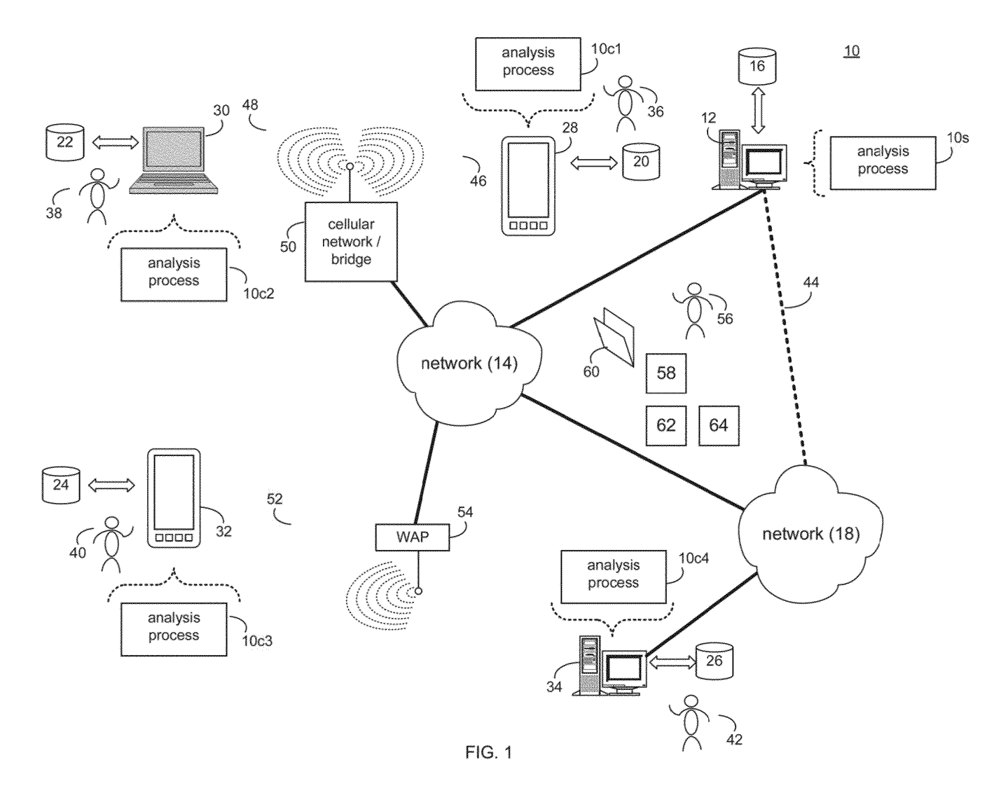

In FIG. 1, there is shown analysis process 10. As will be discussed below in greater detail, analysis process 10 may be utilized to analyze a specific security or a group of securities.

Analysis process 10 may be implemented as a server-side process, a client-side process, or a hybrid server-side/client-side process. For example, analysis process 10 may be implemented as a purely server-side process via analysis process 10s. Alternatively, analysis process 10 may be implemented as a purely client-side process via one or more of client-side application 10c1, client-side application 10c2, client-side application 10c3, and client-side application 10c4. Alternatively still, analysis process 10 may be implemented as a hybrid server-side/client-side process via analysis process 10s in combination with one or more of client-side application 10c1, client-side application 10c2, client-side application 10c3, and client-side application 10c4. Accordingly, analysis process 10 as used in this disclosure may include any combination of analysis process 10s, client-side application 10c1, client-side application 10c2, client-side application 10c3, and client-side application 10c4.

Analysis process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of analysis process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access analysis process 10 directly through network 14 or through secondary network 18. Further, analysis process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Analysis Process:

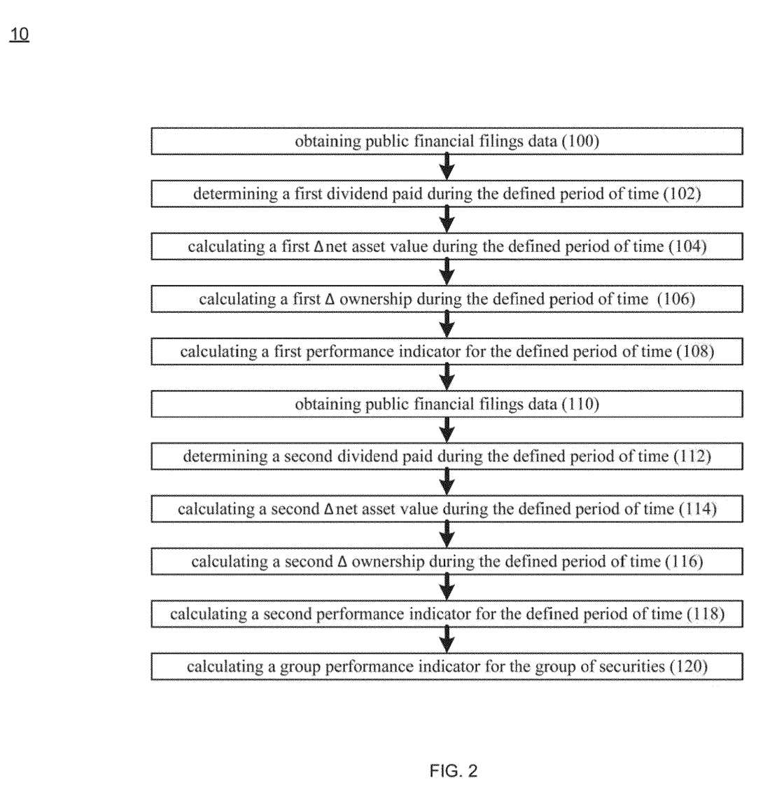

Referring also to FIG. 2, assume for illustrative purpose that user 36 is a financial advisor and wishes to provide their client (e.g., client 56) with a report (e.g., report 58) that analyzes the value of one or more securities included within a group of securities (e.g., portfolio 60).

While the following example concerns the security being a share of stock, this is for illustrative purposes only and is not intended to be a limitation of this disclosure, as other configurations are possible. For example, the security may alternatively/additionally be a bond or an option.

For a first example, assume that portfolio 60 includes one share of Coca Cola stock. Analysis process 10 may obtain 100 public financial filings data 62 for a first security (e.g., the one share of Coca Cola). Public financial filings data 62 may be obtained from various sources such as e.g., The Securities and Exchange Commission (The SEC). Assume for illustrative purposes that the following information is included within public financial filings data 62 obtained 100 by analysis process 10 for shares of Coca Cola.

| Sep. 30, 2012: | Dec. 31, 2012: |
|---|---|
| NAV = $32.25 billion | NAV = $32.79 billion |
| Number of shares = 4.502 billion | Number of shares = 4.485 billion |

Dividend(s) paid in the above period = $0.26 per share

Public financial filings data 62 obtained 100 (in this example) indicates the net asset value (NAV) of Coca Cola as $32.25 billion on 30 Sep. 2012, and $32.79 billion on 31 Dec. 2012. For the following discussion, the time period to be analyzed is a fiscal quarter. However, this is for illustrative purposes only and is not intended to be a limitation of this disclosure. For example, analysis process 10 may be configured to perform the below-described analysis for any time period for which public financial filings data 62 is available. Therefore, if public financial filings data 62 is available in quarterly increments, analysis process 10 may be configured to perform analysis for any time period that is a multiple of such increments (e.g., one quarter, two quarters, three quarters, one year, multiple years, etc.).

For this discussion, the net asset value (NAV) is defined as the net asset value of a company (e.g., Coca Cola), namely the value of a company's assets (e.g., buildings, factories, real estate, inventories, cash, intellectual property) minus the value of the company's liabilities (e.g., monies/debts owed to other parties). Accordingly, the net asset value (NAV) is calculated as:

NAV=total_assets−liabilities

When calculating the net asset value (NAV), intangible assets (such as goodwill) may or may not be included in the calculations. Additionally, for companies that have issued preferred (in addition to common) stock, the net asset value (NAV) attributable to preferred shareholders may or may not be included in the liabilities, thus reducing the amount available to common stock shareholders.

Public financial filings data 62 obtained 100 (in this example) indicates dividends paid during this period as $0.26 per share. For this discussion, dividends are defined as disbursements made from a company to its shareholders. While most dividends are paid in cash, shareholders may sometimes receive additional stock or property in lieu of cash. Dividends are generally reported on a per-share basis. Each company paying a dividend may specify a record date that may be the date on which the company looks at its records to determine who owns the stock and, therefore, is thus entitled to a dividend. Since a stock transaction takes three business days to settle (i.e., the previous owner (or seller) is replaced by the new owner (or buyer) in the company's official records), a stock is said to trade ex-dividend two days prior to the record date, since the buyer will no longer receive the dividend when the stock is purchased on or after the ex-dividend date. So if a stock is purchased three days before the record date, the buyer may be entitled to the dividend because their name will be on the company's record on the record date. However, if a stock is purchased two days before the record date, the buyer may not be entitled to the dividend because his name will not be on the company's record on the record date. It is understood that during any defined period of time being analyzed, two or more discreet dividends may be paid. In such a situation, analysis process 10 may be configured to sum these discreet dividends and use that sum as the dividend paid during the period being analyzed.

Public financial filings data 62 obtained 100 (in this example) indicates the number of outstanding shares of Coca Cola as 4.502 billion on 30 Sep. 2012, and 4.485 billion on 31 Dec. 2012. For this discussion, the number of outstanding shares is the total number of shares that are currently issued with respect to the company (e.g., Coca Cola).

Analysis process 10 may calculate (based, at least in part, upon public financial filings data 62) various indicators for gauging the performance of the security in question (e.g., a share of Coca Cola stock), examples of which may include but are not limited to a first dividend, a first Δ net asset value, and a first Δ ownership are for the first security. These indicators may provide insight into how a company is performing fundamentally, irrespective of the current stock price for a share of that company.

Analysis process 10 may determine 102 a first dividend paid during the defined period of time for the one or more shares of the first security. As shown above and as included within public financial filings data 62, the dividend paid for one share of Coca Cola stock during the period of 30 Sep. 2012-31 Dec. 2012 is $0.26.

Analysis process 10 may calculate 104 a first Δ net asset value (NAV) during the defined period of time for the one or more shares of the first security. As shown above and as included within public financial filings data 62, the net asset value (NAV) of Coca Cola was $32.25 billion on 30 Sep. 2012, and was $32.79 billion on 31 Dec. 2012. Accordingly, the Δ net asset value (NAV) during the defined period of time (i.e., 30 Sep. 2012-31 Dec. 2012) for the first security (e.g., one share of Coca Cola) is $0.12 per share, which is calculated 104 as follows: ($32.79 billion−$32.25 billion)÷4.502 billion shares.

Analysis process 10 may calculate 106 a first Δ ownership during the defined period of time for the one or more shares of the first security. The first Δ ownership during the defined period of time (i.e., 30 Sep. 2012-31 Dec. 2012) for the first security (e.g., one share of Coca Cola) is $0.03 per share, which is calculated 106 as follows: ($32.79 billion×((1 share/4.485 billion shares)−(1 share/4.502 billion shares).

As discussed above and as is known in the art, the ownership of a company is divided into shares each of which represents an equal interest in the company. All else equal, if a company issues more (fewer) shares, then each share will be worth less (more), as it represents a smaller (larger) percentage interest in the company. In other words, the pie representing the company is cut up into more (fewer) but smaller (larger) pieces. While a company may issue a specific number of shares when it starts, the number of shares may go up or down. There are multiple factors that can impact the number of shares outstanding and, hence, each shareholder's percentage ownership in a company (e.g., share buybacks, rights issues, options or stock compensation programs, etc.). The process of creating additional shares is associated with the term dilution.

Accordingly and for one share of Coca Cola, analysis process 10 calculated various indicators for gauging the performance of that share of Coca Cola stock during the time period of 30 Sep. 2012-31 Dec. 2012, wherein these indicators include a first dividend of $0.26 per share of Coca Cola, a first Δ net asset value of $0.12 per share of Coca Cola, and a first Δ ownership of $0.03 per share of Coca Cola.

Analysis process 10 may calculate 108 a first performance indicator for the defined period of time (i.e., 30 Sep. 2012-31 Dec. 2012) for the first security (e.g., one share of Coca Cola) based, at least in part, upon the first dividend, the first Δ net asset value, and the first Δ ownership. For example, the first dividend of $0.26 per share of Coca Cola, the first Δ net asset value of $0.12 per share of Coca Cola, and the first Δ ownership of $0.03 per share of Coca Cola may be provided to the client 56 in tabular form, wherein these three separate values constitute the first performance indicator for one share of Coca Cola. Alternatively, the first dividend of $0.26 per share of Coca Cola, the first Δ net asset value of $0.12 per share of Coca Cola, and the first Δ ownership of $0.03 per share of Coca Cola may be provided to client 56 in summed form, resulting in a first performance indicator of $0.41 per share.

In the event that portfolio 60 includes multiple shares of Coca Cola stock, the above-described indicators may be multiplied by the number of shares. Accordingly, if portfolio 60 includes one hundred shares of Coca Cola stock, the first dividend is $26.00 for portfolio 60, the first Δ net asset value is $12.00 for portfolio 60, and the first Δ ownership is $3.00 for portfolio 60 (each of which may be provided to client 56 in tabular form). In the event that the first performance indicator is provided to client 56 in summed form, the first performance indicator would be $41.00 for portfolio 60.

Assume for illustrative purposes that portfolio 60 includes shares of stock of multiple companies. For example, assume that portfolio 60 includes one hundred shares of Coca Cola, one hundred shares of McDonald's and one hundred shares of Microsoft.

Analysis process 10 may obtain 110 public financial filings data 64 for these additional securities (e.g., the shares of McDonald's and shares of Microsoft). Assume for illustrative purposes that the following information is included within public financial filings data 64 obtained 110 for shares of McDonald's and shares of Microsoft.

For McDonald's:

| Sep. 30, 2012: | Dec. 31, 2012: |
|---|---|
| NAV = $14.04 billion | NAV = $15.29 billion |
| Number of shares = 1.008 billion | Number of shares = 1.004 billion |

Dividend(s) paid in the above period = $0.77 per share

And for Microsoft:

| Sep. 30, 2012: | Dec. 31, 2012: |
|---|---|
| NAV = $66.36 billion | NAV = $72.58 billion |
| Number of shares = 8.383 billion | Number of shares = 8.416 billion |

Dividend(s) paid in the above period = $0.23 per share

In a fashion similar to the manner described above, analysis process 10 may determine 112 a second dividend paid during the defined period of time (i.e., 30 Sep. 2012-31 Dec. 2012) for shares of a second security within portfolio 60. In this example, the second security includes the shares of McDonald's and Microsoft.

For this particular example, the dividend paid for one share of McDonald's stock during the period of 30 Sep. 2012-31 Dec. 2012 is $0.77 and the dividend paid for one share of Microsoft stock during the period of 30 Sep. 2012-31 Dec. 2012 is $0.23

Analysis process 10 may calculate 114 a second Δ net asset value during the defined period of time (i.e., 30 Sep. 2012-31 Dec. 2012) for the shares of the second security within portfolio 60 (e.g., the shares of McDonald's and Microsoft).

For this particular example, the Δ net asset value for one share of McDonald's stock during the period of 30 Sep. 2012-31 Dec. 2012 is $1.25 and the Δ net asset value for one share of Microsoft stock during the period of 30 Sep. 2012-31 Dec. 2012 is $0.74.

Analysis process 10 may calculate 116 a second Δ ownership during the defined period of time (i.e., 30 Sep. 2012-31 Dec. 2012) for the shares of the second security within portfolio 60 (e.g., the shares of McDonald's and Microsoft).

For this particular example, the Δ ownership for one share of McDonald's stock during the period of 30 Sep. 2012-31 Dec. 2012 is $0.07 and the Δ net asset value for one share of Microsoft stock during the period of 30 Sep. 2012-31 Dec. 2012 is −$0.03.

And in a fashion similar to that described above, analysis process 10 may calculate 118 a second performance indicator for the defined period of time (i.e., 30 Sep. 2012-31 Dec. 2012) for the shares of the second security (e.g., the shares of McDonald's and Microsoft) based, at least in part, upon the second dividend, the second Δ net asset value, and the second Δ ownership.

Analysis process 10 may present this information to client 56 in tabular form, which indicates the dividend, Δ net asset value and Δ ownership for each of one share of Coca Cola, McDonald's and Microsoft (as shown below), wherein these three separate values constitute the performance indicator for each share of each stock.

| | CocaCola | McDonald's | Microsoft |
|---|---|---|---|
| Dividends | $0.26 | $0.77 | $0.23 |
| Change in NAV | $0.12 | $1.25 | $0.74 |
| Change in OI | $0.03 | $0.07 | −$0.03 |

Further and as discussed above, analysis process 10 may present the dividend, Δ net asset value, and Δ ownership for each share of each stock in a summed fashion (as shown below), wherein these three sums constitute the performance indicator for each share of each stock.

| | CocaCola | McDonald's | Microsoft |
|---|---|---|---|
| Dividends | $0.26 | $0.77 | $0.23 |
| Change in NAV | $0.12 | $1.25 | $0.74 |
| Change in OI | $0.03 | $0.07 | −$0.03 |
| Sum | $0.41 | $2.09 | $0.94 |

Additionally and as this is an analysis of portfolio 60, analysis process 10 may present the dividends, Δ net asset values, and Δ ownerships on a portfolio basis. For example and as discussed above, client 56 owns one hundred shares of each of Coca Cola stock, McDonald's stock and Microsoft stock. Accordingly, each value of the above table may be multiplied by one hundred to show the value of the portfolio (as shown below).

| | CocaCola | McDonald's | Microsoft |
|---|---|---|---|
| Dividends | $26.00 | $77.00 | $23.00 |
| Change in NAV | $12.00 | $125.00 | $74.00 |
| Change in OI | $3.00 | $7.00 | −$3.00 |
| Sum | $41.00 | $209.00 | $94.00 |

Analysis process 10 may calculate 120 a group performance indicator for the group of securities (e.g., portfolio 60) based, at least in part, upon the above-described performance indicators. For example, analysis process 10 may sum all the dividends, all the Δ net asset values, and all the Δ ownerships (as shown below) and present them on a portfolio basis. For example, portfolio 60 produced $126.00 in dividends, $211.00 in Δ net asset values, and $7.00 in Δ ownerships on a portfolio basis.

| | CocaCola | McDonald's | Microsoft | Sum |
|---|---|---|---|---|
| Dividends | $26.00 | $77.00 | $23.00 | $126.00 |
| Change in NAV | $12.00 | $125.00 | $74.00 | $211.00 |
| Change in OI | $3.00 | $7.00 | −$3.00 | $7.00 |
| Sum | $41.00 | $209.00 | $94.00 | $344.00 |

Additionally and as shown above, analysis process 10 may sum the above-described sums to give an indicator of the performance of portfolio 60 as a whole. Accordingly, analysis process 10 may sum the $126.00 in dividends, the $211.00 in Δ net asset values, and the $7.00 in Δ ownerships to provide an indicator concerning the performance of portfolio 56, namely $344.00 (as shown above).

Further, analysis process 10 may be configured to perform the above-described calculations for multiple quarters, wherein this data may be provided to client 56 in tabular form (as shown below).

| | Q1 | Q2 | Q3 | Q4 |
|---|---|---|---|---|
| Dividends | $126.00 | $115.00 | $123.00 | $98.00 |
| Change in NAV | $211.00 | $189.00 | −$70.00 | $133.00 |
| Change in OI | $7.00 | $5.00 | $12.00 | $6.00 |

Additionally, analysis process 10 may be configured to perform the above-described calculations for multiple quarters, wherein this data may be provided to client 56 in a cumulative tabular form (as shown below).

| | | | | Q1 + Q2 + |
|---|---|---|---|---|
| | Q1 | Q1 + Q2 | Q1 + Q2 + Q3 | Q3 + Q4 |
| Dividends | $126.00 | $241.00 | $364.00 | $462.00 |
| Change in NAV | $211.00 | $400.00 | $330.00 | $463.00 |
| Change in OI | $7.00 | $12.00 | $24.00 | $6.00 |
| Total | $126.00 | $653.00 | $718.00 | $931.00 |

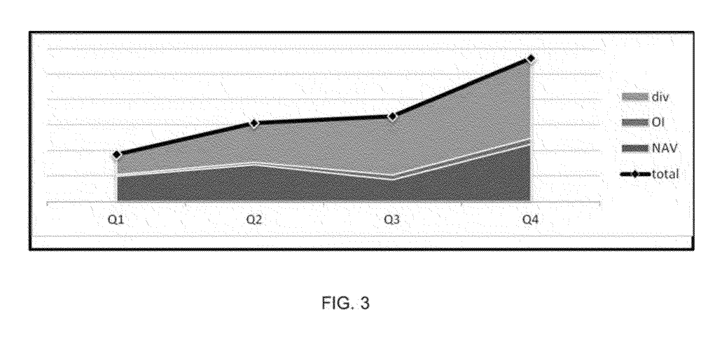

Further, analysis process 10 may be configured to perform the above-described calculations for multiple quarters, wherein this data may be provided to client 56 in a cumulative graphic form (as shown in FIG. 3).

When summing e.g., dividends across a larger period of time (e.g., one that spans multiple quarters as shown above), analysis process 10 may utilize time value of money calculations that take into account situations that may impact the value of a currency (e.g., inflation, deflation, interest rates, etc.).

While the discussion above concerned the individual securities being within a stock portfolio, this is for illustrative purposes only and is not intended to be a limitation of this disclosure, as other configurations are possible. For example, the individual securities may be included within a mutual fund.

While the above discussion concerned analysis process 10 performing analysis on security performance during a defined period of time, it is understood that the “defined period of time” for the first security may not perfectly overlap with the “defined period of time” for the second security (or other securities in the portfolio). For example, the defined period of time for the first security may be from 30 Sep. 2012 to 31 Dec. 2012, wherein the “defined period of time” for the second security may be from 15 Sep. 2012-15 Dec. 2012. In such a situation, analysis process 10 may be configured to maximize overlap (or may utilize some other reasonable approach).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method for analyzing one or more shares of a first security during a defined period of time comprising:
determining a first dividend paid during the defined period of time for the one or more shares of the first security;
calculating a first Δ net asset value during the defined period of time for the one or more shares of the first security;
calculating a first Δ ownership during the defined period of time for the one or more shares of the first security; and
calculating a first performance indicator for the defined period of time for the one or more shares of the first security based, at least in part, upon the first dividend, the first Δ net asset value, and the first Δ ownership.

2. The computer-implemented method of claim 1 further comprising:
obtaining public financial filings data for the first security;
wherein the first dividend, the first Δ net asset value, and the first Δ ownership are based, at least in part, upon the public financial filings data for the first security.

3. The computer-implemented method of claim 1 wherein:
the one or more shares of the first security are included within a group of securities; and
the group of securities further includes one or more shares of a second security.

4. The computer-implemented method of claim 3 wherein the group of securities is included within a stock portfolio.

5. The computer-implemented method of claim 3 wherein the group of securities is included within a mutual fund.

6. The computer-implemented method of claim 3 further comprising:
determining a second dividend paid during the defined period of time for the one or more shares of the second security;
calculating a second Δ net asset value during the defined period of time for the one or more shares of the second security;
calculating a second Δ ownership during the defined period of time for the one or more shares of the second security; and
calculating a second performance indicator for the defined period of time for the one or more shares of the second security based, at least in part, upon the second dividend, the second Δ net asset value, and the second Δ ownership.

7. The computer-implemented method of claim 6 further comprising:
calculating a group performance indicator for the group of securities based, at least in part, upon the first performance indicator and the second performance indicator.

8. A computer program product residing on a computer readable medium having a plurality of instructions stored thereon which, when executed by a processor, cause the processor to perform operations comprising:
determining a first dividend paid during the defined period of time for the one or more shares of the first security;
calculating a first Δ net asset value during the defined period of time for the one or more shares of the first security;
calculating a first Δ ownership during the defined period of time for the one or more shares of the first security; and
calculating a first performance indicator for the defined period of time for the one or more shares of the first security based, at least in part, upon the first dividend, the first Δ net asset value, and the first Δ ownership.

9. The computer program product of claim 8 further comprising instructions to perform operations comprising:
obtaining public financial filings data for the first security;
wherein the first dividend, the first Δ net asset value, and the first Δ ownership are based, at least in part, upon the public financial filings data for the first security.

10. The computer program product of claim 8 wherein:
the one or more shares of the first security are included within a group of securities; and
the group of securities further includes one or more shares of a second security.

11. The computer program product of claim 10 wherein the group of securities is included within a stock portfolio.

12. The computer program product of claim 10 wherein the group of securities is included within a mutual fund.

13. The computer program product of claim 10 further comprising instructions to perform operations comprising:
determining a second dividend paid during the defined period of time for the one or more shares of the second security;
calculating a second Δ net asset value during the defined period of time for the one or more shares of the second security;
calculating a second Δ ownership during the defined period of time for the one or more shares of the second security; and
calculating a second performance indicator for the defined period of time for the one or more shares of the second security based, at least in part, upon the second dividend, the second Δ net asset value, and the second Δ ownership.

14. The computer program product of claim 13 further comprising instructions to perform operations comprising:
calculating a group performance indicator for the group of securities based, at least in part, upon the first performance indicator and the second performance indicator.

15. A computing system including a processor and memory configured to perform operations comprising:
determining a first dividend paid during the defined period of time for the one or more shares of the first security;
calculating a first Δ net asset value during the defined period of time for the one or more shares of the first security;
calculating a first Δ ownership during the defined period of time for the one or more shares of the first security; and
calculating a first performance indicator for the defined period of time for the one or more shares of the first security based, at least in part, upon the first dividend, the first Δ net asset value, and the first Δ ownership.

16. The computing system of claim 15 further configured to perform operations comprising:
obtaining public financial filings data for the first security;
wherein the first dividend, the first Δ net asset value, and the first Δ ownership are based, at least in part, upon the public financial filings data for the first security.

17. The computing system of claim 15 wherein:
the one or more shares of the first security are included within a group of securities; and
the group of securities further includes one or more shares of a second security.

18. The computing system of claim 17 wherein the group of securities is included within a stock portfolio.

19. The computing system of claim 17 wherein the group of securities is included within a mutual fund.

20. The computing system of claim 17 further configured to perform operations comprising:
determining a second dividend paid during the defined period of time for the one or more shares of the second security;
calculating a second Δ net asset value during the defined period of time for the one or more shares of the second security;
calculating a second Δ ownership during the defined period of time for the one or more shares of the second security; and
calculating a second performance indicator for the defined period of time for the one or more shares of the second security based, at least in part, upon the second dividend, the second Δ net asset value, and the second Δ ownership.

21. The computing system of claim 20 further configured to perform operations comprising:
calculating a group performance indicator for the group of securities based, at least in part, upon the first performance indicator and the second performance indicator.
